(19) United States
(12) Patent Application Publication
(10) Pub. No.: US 2016/0086446 A1
(43) Pub. Date: Mar. 24, 2016

(54) SYSTEMS, APPARATUSES, AND METHODS FOR OPERATING AN ELECTRONIC GAME

(71) Applicant: Joseph Versaci, Las Vegas, NV (US)

(72) Inventor: Joseph Versaci, Las Vegas, NV (US)

(21) Appl. No.: 14/873,856

(22) Filed: Oct. 2, 2015

Related U.S. Application Data
(63) Continuation of application No. PCT/US15/51278, filed on Sep. 21, 2015.
(60) Provisional application No. 62/052,935, filed on Sep. 19, 2014.

(51) Int. Cl. G07F 17/32

(52) U.S. Cl. CPC G07F 17/3255; G07F 17/3204

(57) ABSTRACT

A method for operating an electronic game is disclosed, including receiving a request to participate in an electronic game, displaying an advertisement, generating at least a portion of advertising revenue based on the displayed advertisement, adding at least a portion of the generated advertising revenue as currency to the electronic game, allowing participation in the electronic game, determining whether a condition has been met indicating that a user has won the electronic game, and distributing at least a portion of the currency to the winning user.

### BACKGROUND

1. Technical Field

The present disclosure relates to electronic gaming, and specifically, to systems, apparatuses, and methods for operating an electronic game by using advertisements to generate winnable game currency.

2. Background of Related Art

Generally, electronic gaming systems come in two formats. The first format is a free-to-play, where the user is allowed to participate in the electronic game without having to pay, and without the possibility of winning any actual currency. In other words, the user is only playing for digital points or a “high score.” The second format is pay-to-play, where the user must pay actual currency up front, and then wager either the actual currency or digital currency purchased with the actual currency to win more actual or digital currency.

### SUMMARY

Provided in accordance with the present disclosure is a method for operating an electronic gaming system.

In an aspect of the present disclosure, the method includes receiving a request to participate in an electronic game, displaying an advertisement, generating at least a portion of advertising revenue based on the displayed advertisement, adding at least a portion of the generated advertising revenue as currency to the electronic game, allowing participation in the electronic game, determining whether a condition has been met indicating that a user has won the electronic game, and distributing at least a portion of the currency to the winning user.

In another aspect of the present disclosure, the advertisement is a pre-roll advertisement.

In yet another aspect of the present disclosure, the electronic game is an electronic gambling game.

In another aspect of the present disclosure, the advertising revenue is added to the winnable pot of the electronic gambling game.

In yet another aspect of the present disclosure, the advertising revenue is converted into digital currency.

In another aspect of the present disclosure, the advertising revenue is converted into game points.

In yet another aspect of the present disclosure, the method further comprises displaying a banner advertisement.

In a further aspect of the present disclosure, at a predetermined interval, the displayed banner advertisement is a special banner advertisement which generates a prize if selected by a user.

Any of the above aspects and embodiments of the present disclosure may be combined without departing from the scope of the present disclosure.

### BRIEF DESCRIPTION OF THE DRAWINGS

The present disclosure may be understood by reference to the accompanying drawings, when considered in conjunction with the subsequent, detailed description, in which:

FIG. 1A is a diagram of a system for operating an electronic game, provided in accordance with an embodiment of the present disclosure;

FIG. 1B is a diagram of a system for operating an electronic game, provided in accordance with another embodiment of the present disclosure;

FIG. 2 is a schematic diagram of a content-providing device forming part of the system of FIG. 1A or FIG. 1B, provided in accordance with an embodiment of the present disclosure;

FIG. 3A is a chart showing the operations performed by each of the devices of the system of FIG. 1A;

FIG. 3B is a chart showing the operations performed by each of the devices of the system of FIG. 1B;

FIG. 4 is a chart illustrating the output displayed by a user device forming part of the system of FIG. 1A or FIG. 1B, provided in accordance with another embodiment of the present disclosure;

FIG. 5 is a flowchart illustrating an example method for operating an electronic game, provided in accordance with an embodiment of the present disclosure;

FIG. 6 is an illustration of an example user interface of an electronic game, provided in accordance with an embodiment of the present disclosure;

FIG. 7 is another illustration of an example user interface of an electronic game, provided in accordance with an embodiment of the present disclosure;

FIG. 8 is yet another illustration of an example user interface of an electronic game, provided in accordance with an embodiment of the present disclosure; and

FIG. 9 is yet another illustration of an example user interface of an electronic game, provided in accordance with an embodiment of the present disclosure.

### DETAILED DESCRIPTION

A system for operating an electronic game is disclosed. In accordance with the present disclosure, the system may operate an electronic game by requiring user devices requesting participation in the electronic game to display an advertisement prior to allowing such user devices to participate in the electronic game. The system may then convert advertising revenue received for displaying the advertisement into currency to be added to the electronic game, and distribute the currency to a user who wins the electronic game.

Detailed embodiments of devices configured to operate in an electronic gaming system, systems incorporating these devices, and methods using these devices as described below. However, these detailed embodiments are merely examples of the disclosure, which may be embodied in various forms. Therefore, specific structural and functional details disclosed herein are not to be interpreted as limiting, but merely as a basis for the claims and as a representative basis for allowing one skilled in the art to variously employ the present disclosure in virtually any appropriately detailed structure.

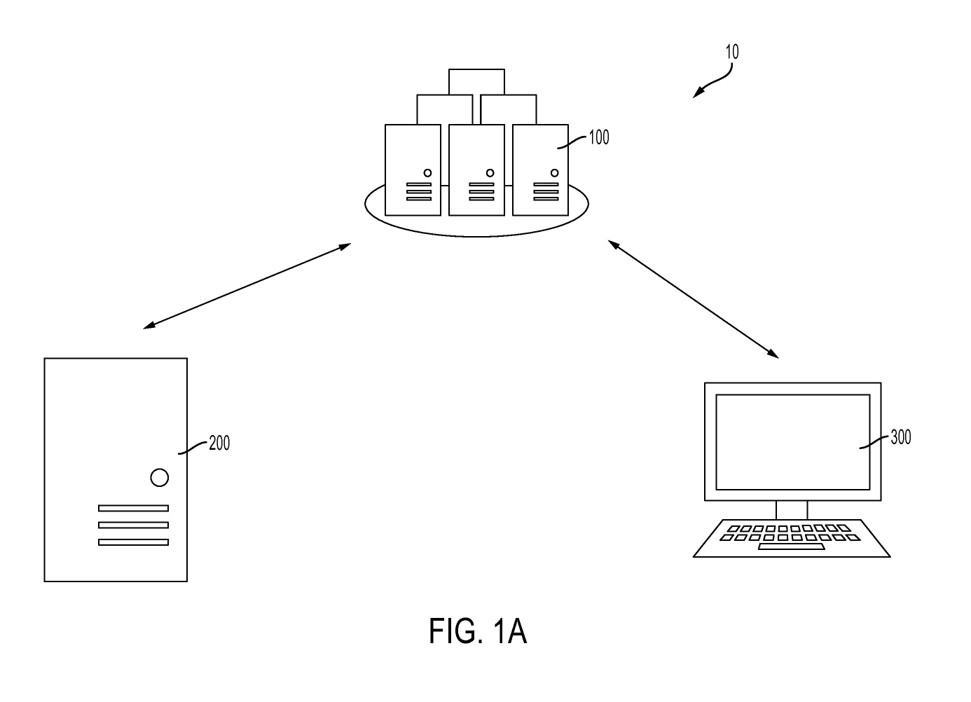

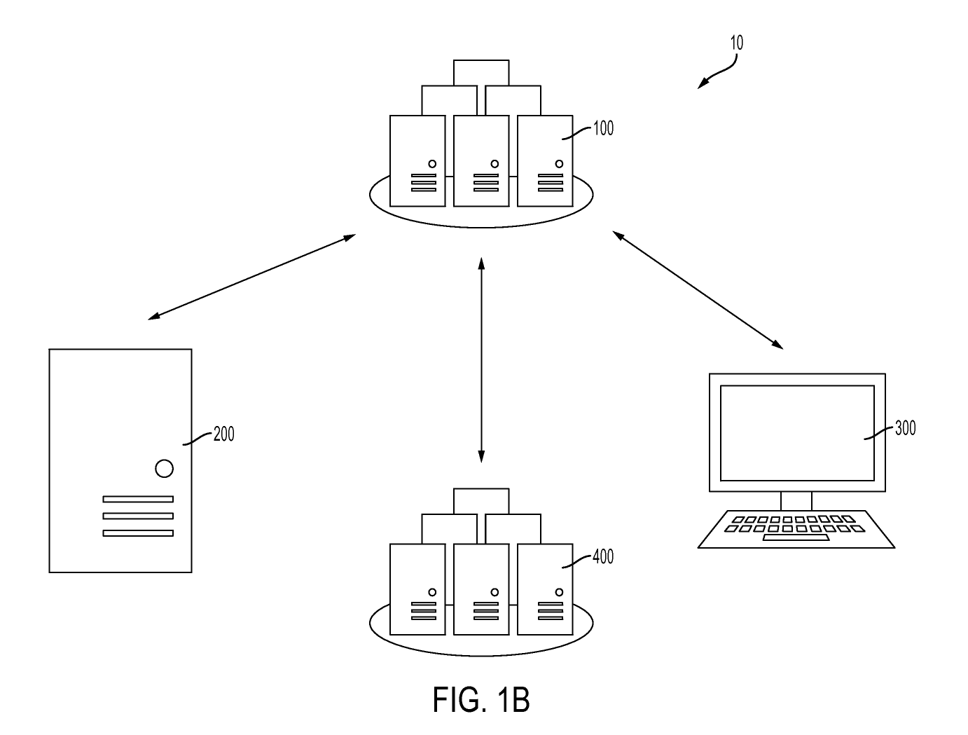

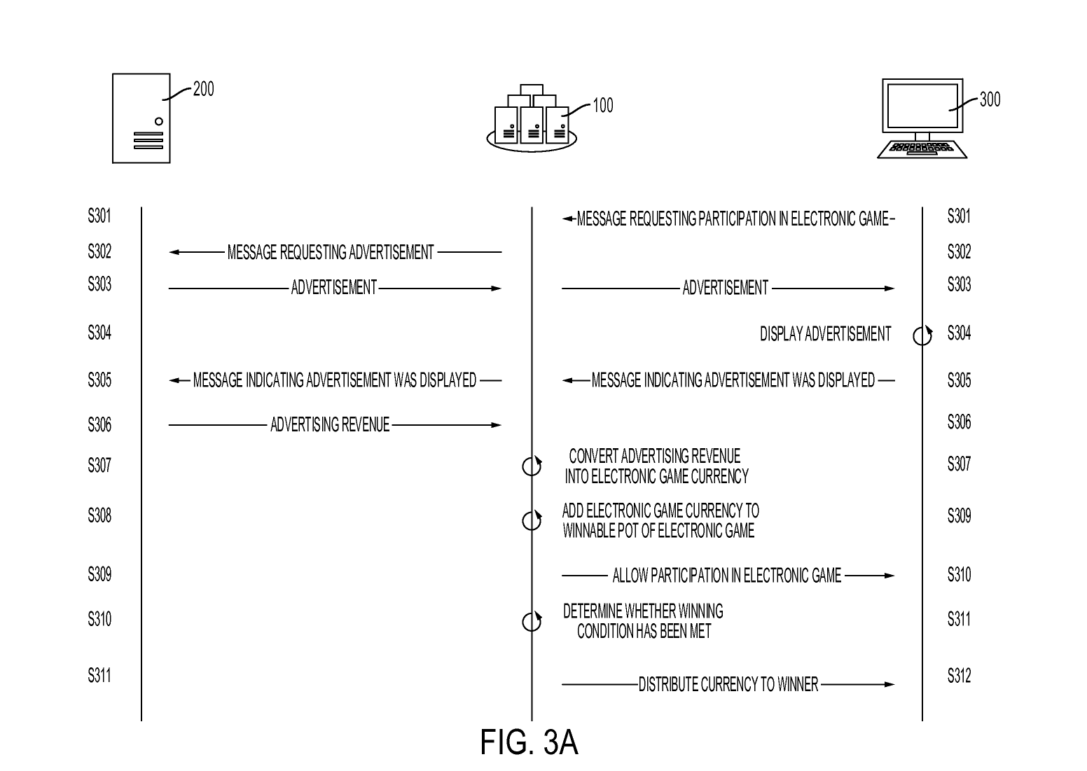

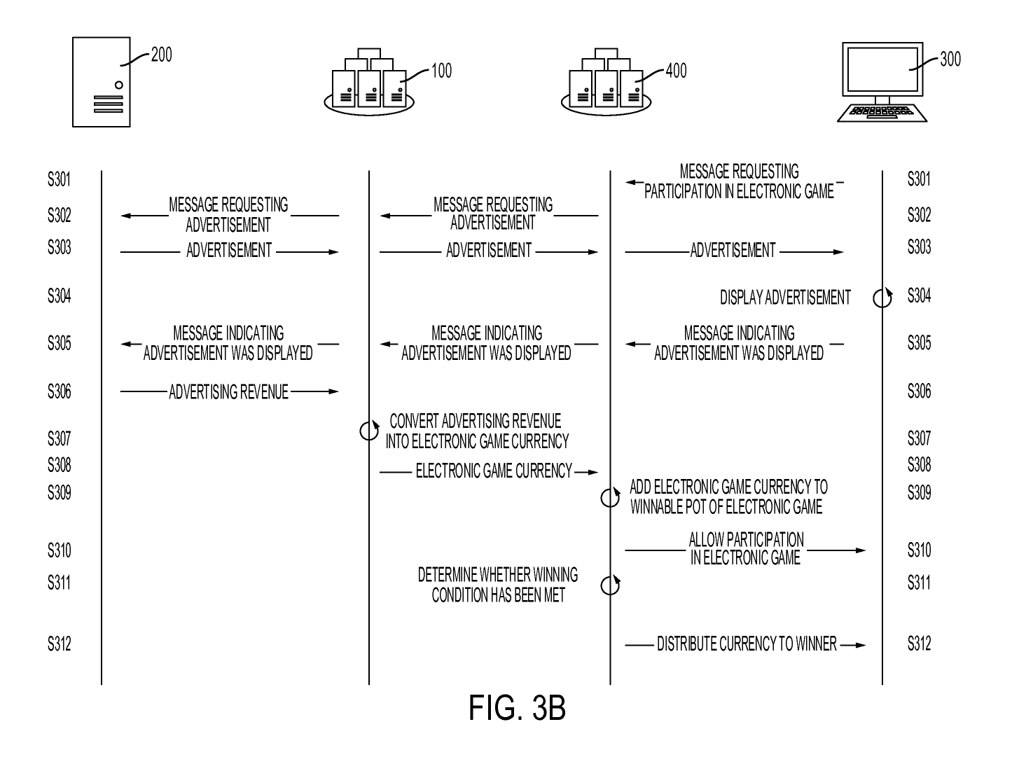

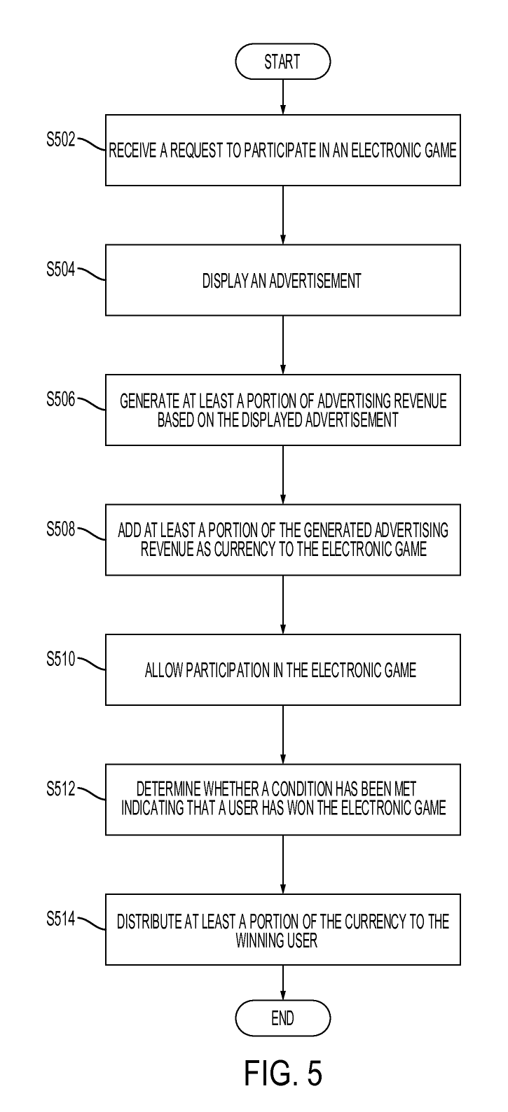

With reference to the drawings, FIG. 1A shows a diagram of a system 10 in accordance with the present disclosure. System 10 includes a content-providing device 100, an advertisement-providing device 200, and a user device 300. Content-providing device 100 may be any computer or collection of computers, server or array of servers, or other device known to those skilled in the art which can be configured to host and/or operate an electronic game. Content-providing device 100 may be located on-site at a location where the electronic game is played, or it may be located off-site and is accessible via a network such as, for example, the internet. Content-providing device 100 may be configured to operate in a cloud-based environment. As described in more detail with reference to FIG. 3A, FIG. 3B, and FIG. 5 below, content-providing device 100 may be configured to request and provide advertisements whereby advertising revenue is generated which can be converted into currency to be used with the electronic game. For example, content-providing device 100 may located in a server farm, and may host and operate the electronic game using a website accessible via the internet. Alternatively, content-providing device 100 may host and operate the electronic game in a manner which can be accessed via an application installed on user device 300.

Advertisement-providing device 200 may be any computer or collection of computers, server or array of servers, or other device known to those skilled in the art which can be configured to manage and send advertisements to other devices. Advertisement-providing device 200 may be located on-site at a location where the electronic game is played, or it may be located off-site and is accessible via a network such as, for example, the internet. Advertisement-providing device 200 may be configured to operate in a cloud-based environment. For example, advertisement-providing device 200 may be located at an advertising agency which provides advertisements to content providers to be displayed on websites and/or applications, and in return for displaying the advertisements, provides advertising revenue to the content providers.

User device 300 may be any one or more of a personal computer, desktop computer, laptop computer, tablet computer, smartphone, smartwatch, or any other type of computer known to those skilled in the art which can be configured to participate in an electronic game.

FIG. 1B shows a diagram of a system 10 including the same or similar devices as described above with reference to FIG. 1A, and also including a game-operating device 400. Game-operating device 400 may be any computer or collection of computers, server or array of servers, or other device known to those skilled in the art which can be configured to host and/or operate the electronic game. Game-operating device 400 may be located on-site at a location where the electronic game is played, or it may be located off-site and is accessible via a network such as, for example, the internet. Game-operating device 400 may be configured to operate in a cloud-based environment. For example, game-operating device 400 may located in a server farm, and may host and operate the electronic game using a website accessible via the internet. Alternatively, game-operating device 400 may host and operate the electronic game in a manner which can be accessed via an application installed on user device 300. In this embodiment, content providing device 100 is not configured to operate the electronic game.

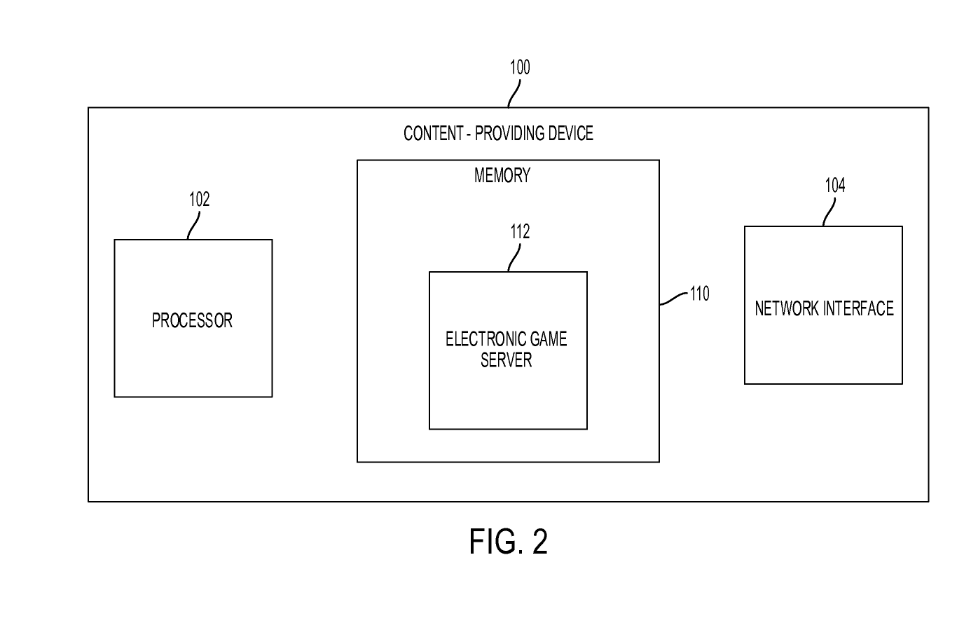

Referring now to FIG. 2, there is shown a schematic diagram of content-providing device in accordance with an embodiment of the present disclosure. Content-providing device 100 may include a processor 102, a network interface 104, and a memory 110 for storing an electronic game server 112. The processor 102 is configured to access the memory 110 in order to execute the instructions for operating the electronic game server 112. Network interface 108 may be one or more of a local area network (LAN) device, wide area network (WAN) device, a BLUETOOTH® device, a near-field communication (NFC) device, a cellular networking device using the global system for mobile communications (GSM), code division multiple access (CDMA), and/or other cellular networking standards, and/or any other networking devices known to those skilled in the art, and may be configured for wired and/or wireless communication.

In an embodiment, memory 110 may include one or more solid-state storage devices such as flash memory chips. Alternatively or in addition to the one or more solid-state storage devices, memory 110 may include one or more mass storage devices connected to the processor 102 through a mass storage controller (not shown) and a communications bus (not shown). Although the description of computer-readable media contained herein refers to a solid-state storage, it should be appreciated by those skilled in the art that computer-readable storage media may be any available media that can be accessed by the processor 102. That is, computer readable storage media may include non-transitory, volatile and non-volatile, removable and non-removable media implemented in any method or technology for storage of information such as computer-readable instructions, data structures, program modules or other data. For example, computer-readable storage media includes RAM, ROM, EPROM, EEPROM, flash memory or other solid state memory technology, CD-ROM, DVD, Blu-Ray or other optical storage, magnetic cassettes, magnetic tape, magnetic disk storage or other magnetic storage devices, or any other medium which can be used to store the desired information and which can be accessed by content-providing device 100.

Turning now to FIG. 3A, there is shown a chart showing the operations performed by each of the devices of the system 10 as shown in FIG. 1A. At step S301, user device 300 sends a message requesting participation in an electronic game to content-providing device 100. The electronic game may be any electronic game that is operable by content-providing device 100, such as, for example, a browser-based video game, single player online video game, a massively multiplayer online role-playing game (MMORPG), an electronic gambling game, and/or any other electronic game known to those skilled in the art, or any combination of such electronic games.

At step S302, content-providing device 100 requests an advertisement from advertisement-providing device 200. Then, at step S303, advertisement-providing device 200 sends an advertisement to content-providing device 100, and content-providing device 100 in turn sends the advertisement to user device 300. At step S304, user device 300 displays the advertisement.

The advertisement may be any advertisement that is displayable on user device 300, such as, for example, a video advertisement including a pre-roll video advertisement, a still image advertisement, a banner advertisement, and/or any other advertisement known to those skilled in the art, or any combination of such advertisements. The advertisement may have a time component associated therewith, requiring it to be displayed for at least a predetermined length of time. The advertisement may also include a user-interaction component, for example, a requirement that the user select a button or enter information prior to the advertisement being completed.

For example, when a banner advertisement is displayed, the banner advertisement may be either of a regular banner advertisement and a special banner advertisement. The regular banner advertisement and special banner advertisement may appear identical to the user, but selecting the special banner advertisement may result in a prize and/or electronic game bonus for the user. The special banner advertisement may be displayed at a predetermined interval, for example, every one-thousandth time that a banner advertisement is displayed.

Thereafter, at step S305, user device 300 sends a message indicating that the advertisement was displayed to content-providing device 100, and content-providing device 100 sends the message indicating that the advertisement was displayed to advertisement-providing device 200. Advertisement-providing device 200 then, at step S306, sends advertising revenue to content-providing device 100. At step S307, content-providing device 100 converts at least a portion of the received advertising revenue into currency that can be used in the electronic game.

Thereafter, at step S309, content-providing device 100 adds at least a portion of the received currency to the winnable pot of the electronic game that can be won by satisfying a winning condition of the electronic game. The advertising revenue may be converted into digital currency, game points, and/or any other type of currency usable by an electronic game known to those skilled in the art, or any combination of such currency forms. If the electronic game is an electronic gambling game, the advertising revenue may be added to the winnable pot of the electronic gambling game. Then, at step S310, content-providing device 100 allows user device 300 to participate in the electronic game.

Content-providing device 100 monitors the electronic game to determine whether a winning condition has been met at step S311. When a winning condition is met, at step S312, content-providing device 100 distributes at least a portion of the currency that can be won to the winner.

In the embodiment shown in FIG. 3B, game-operating device 400 operates the electronic game, instead of content-providing device 100 as in FIG. 3A. Thus, at step S301, user device 300 sends a message requesting participation in the electronic game to game-operating device 400. Thereafter, at step S302, game-operating device 400 sends a message requesting an advertisement to content-providing device 100, which content-providing device 100 in turn sends to advertisement-providing device 200. Upon receiving the message requesting an advertisement, advertisement-providing device 200 sends, at step S303, an advertisement to content-providing device 100, which content-providing device 100 sends to user device 300. The advertisement may be sent directly from content-providing device 100 to user device 300, or may be sent via game-operating device 400.

At step S304, user device 300 displays the advertisement, and at step S305 user device 300 sends a message indicating the advertisement was displayed to content-providing device 100. The message indicating the advertisement was displayed may be sent directly to content-providing device 100, or may be sent via game-operating device 300, according to the method used in step S303. Content-providing device 100 then sends the message indicating that the advertisement was displayed to advertisement-providing device 200. Upon receipt, advertisement-providing device 200 sends, at step S306, advertising revenue to content-providing device 100.

At step S307, content-providing device 100 converts at least a portion of the received advertising revenue to electronic game currency, and, at step S308, sends the electronic game currency to game-operating device 400. Game-operating device 400 then, at step S309, adds at least a portion of the received electronic game currency to the winnable pot of the electronic game, and sends a message to user device 300 allowing user device 300 to participate in the electronic game. Game-operating device 400 monitors the electronic game to determine whether a winning condition has been met at step S311. When a winning condition is met, at step S312, game-operating device 400 distributes at least a portion of the currency that can be won to the winner.

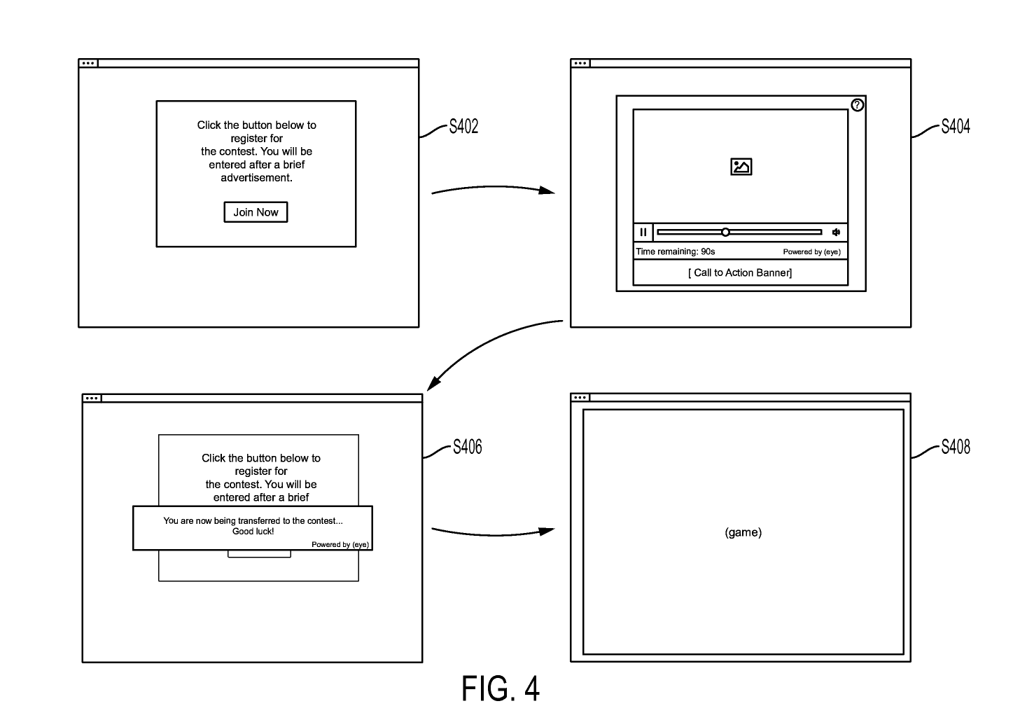

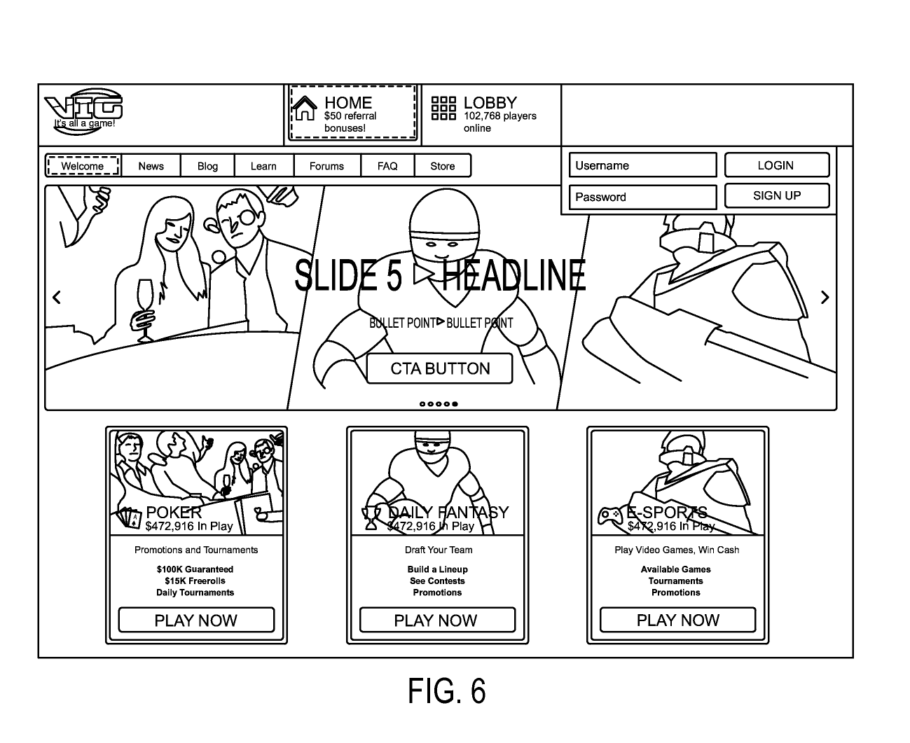

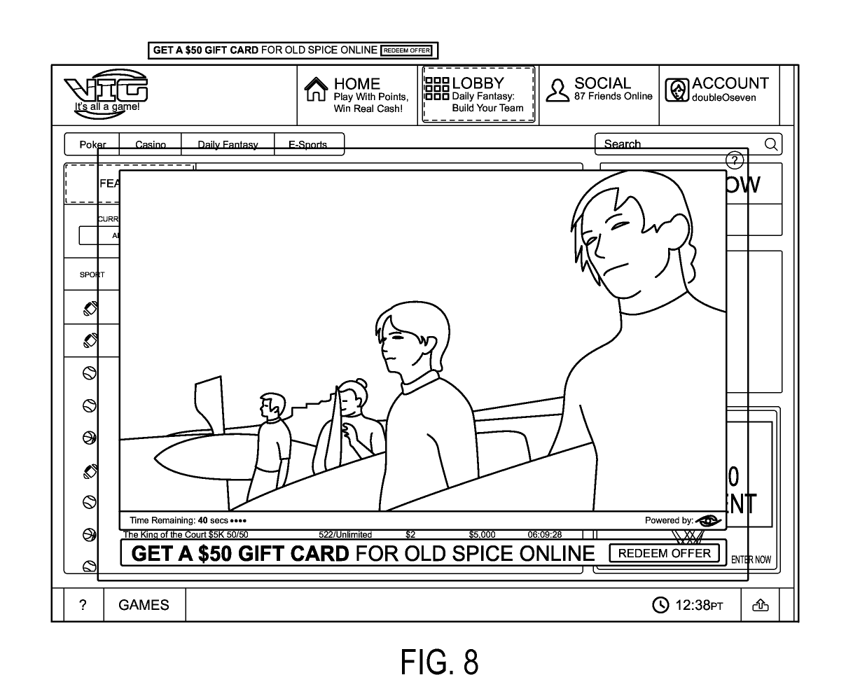

Referring now to FIG. 4, there is shown a chart illustrating the output displayed by the user device 300 of system 10. Upon selecting an electronic game to enter, at step S402, user device 300 displays to the user a screen indicating that the user may participate in the game by watching an advertisement. For example, user device 300 may display to the user a screen such as shown in FIG. 6. If the user elects to watch the advertisement, user device 300, at step S404, displays to the user a screen including the advertisement. For example, user device 300 may display to the user a screen such as shown in FIG. 8.

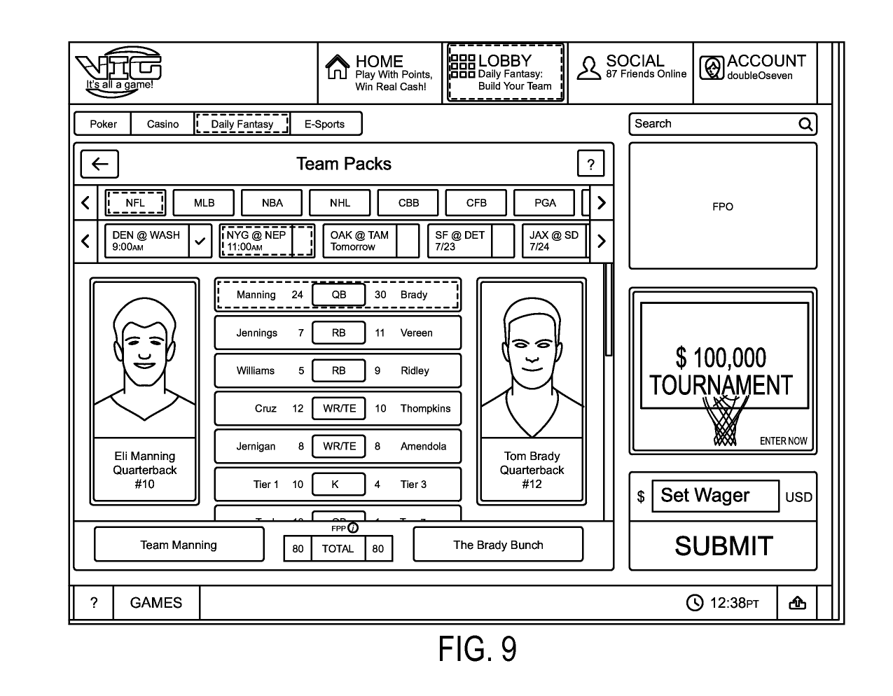

The advertisement screen may include a video player section and/or a banner section. When the advertisement has been displayed, user device 300, at step S406, displays a screen indicating that the user is being entered into the electronic game. Thereafter, at step S408, user device 300 displays a screen containing the electronic game. For example, user device 300 may display to the user a screen such as shown in FIG. 9.

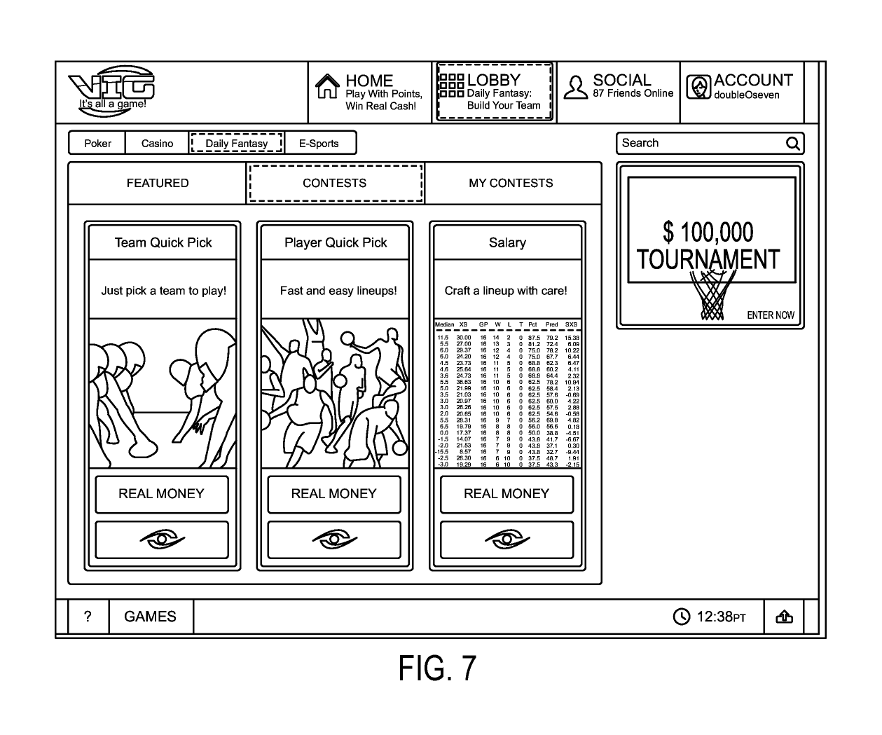

In an example embodiment, user device 300 may display to the user a screen allowing the user to log in to an electronic game operated by content-providing device 100 or game-operating device 400, as shown in FIG. 6. Once the user has logged in to the electronic game hosted by content-providing device 100 or game-operating device 400, user device 300 may display a screen allowing the user to select an electronic game to play from various electronic games operated by content-providing device 100 or game-operating device 400, as shown in FIG. 7. For example, the user may select to play a “Daily Fantasy” electronic game, as shown in FIG. 7. Once the user selects which electronic game to play, user device 300 displays the advertisement received from advertisement-providing device 200 before allowing the user to access the electronic game, as shown in FIG. 8. Once the advertisement has finished playing, the user is allowed to access the electronic game, and a portion of the electronic game currency is added to the winnable pot of the electronic game, as shown in FIG. 9.

Turning now to FIG. 5, there is shown a flowchart illustrating an example method for operating an electronic game, such as may be performed by content-providing device 100. Processing may begin at step S502, where content-providing device 100 receives a request to allow user device 300 to participate in an electronic game operated by content-providing device 100.

Thereafter, at step S504, content-providing device 100 provides user device 300 with an advertisement and awaits information from user device 300 indicating that the advertisement has been displayed. Upon receiving such information indicating that the advertisement has been displayed, at step S506, content-providing device 100 generates at least a portion of advertising revenue based on the displayed advertisement. Then, at step S508, content-providing device 100 adds at least a portion of the generated advertising revenue as currency to the electronic game.

At step S510, content-providing device 100 allows user device 300 to participate in the electronic game. Thereafter, at step S512, content-providing device 100 monitors the electronic game to determine whether a condition has been met indicating that a user has won the electronic game. If content-providing device 100 determines that a user has won the electronic game, content-providing device 100, at step S514, distributes at least a portion of the currency to the winning user.

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

What is claimed is:

1. A method for operating an electronic gaming system, the method comprising:
receiving a message requesting participation in an electronic game from a user device;
providing an advertisement to be displayed to the user device;
receiving a message, from the user device, indicating that the advertisement has been displayed;
generating at least a portion of advertising revenue based on the displayed advertisement;
adding at least a portion of the generated advertising revenue as currency to the electronic game; and
allowing participation in the electronic game.

2. The method according to claim 1, wherein the advertisement is a pre-roll advertisement.

3. The method according to claim 1, wherein the electronic game is an electronic gambling game.

4. The method according to claim 3, wherein the advertising revenue is added to a winnable pot of the electronic gambling game.

5. The method according to claim 1, wherein the advertising revenue is converted into digital currency.

6. The method according to claim 1, wherein the advertising revenue is converted into game points.

7. The method according to claim 1, further comprising displaying a banner advertisement.

8. The method according to claim 7, wherein, at a predetermined interval, the displayed banner advertisement is a special banner advertisement which generates a prize if selected by a user.

9. A system for operating an electronic gaming system, the system including a content-providing device including a processor and a memory storing instructions which, when executed by the processor, cause the content-providing device to:
receive, from a game-operating device, a message requesting an advertisement;
send, to an advertisement-providing device, a message requesting an advertisement;
receive, from the advertisement-providing device, an advertisement;
send, to the game-operating device, the advertisement;
receive, from the game-operating device, a message indicating that the advertisement has been displayed by a user device;
send, to the advertisement-providing device, a message indicating that the advertisement has been displayed;
receive, from the advertisement-providing device, advertising revenue based on the displayed advertisement;
generate currency based on at least a portion of the received advertising revenue; and
send, to the game-operating device, the currency,
wherein the game-operating device is configured to:
receive, from the user device, a message requesting participation in the electronic game;
send, to the content-providing device, the message requesting an advertisement;
receive the advertisement from the content-providing device;
send the advertisement to the user device;
receive, from the user device, the message indicating that the advertisement has been displayed;
send, to the content-providing device, the message indicating that the advertisement has been displayed;
receive the currency from the content-providing device;
add at least a portion of the received currency to the winnable pot of the electronic game;
send, to the user device, a message allowing the user device to participate in the electronic game;
wherein the advertisement-providing device configured to:
receive, from the content-providing device, the message requesting an advertisement;
send the advertisement to the content-providing device;
receive, from the content-providing device, the message indicating that the advertisement has been displayed; and
send, to the content-providing device, advertising revenue based on the displayed advertisement, and
wherein the user device configured to:
send, to the game-operating device, a message requesting participation in the electronic game;
receive, from the game-operating device, the advertisement to display;
display the advertisement;
send, to the game-operating device, a message indicating that the that the advertisement has been displayed; and
receive, from the game-operating device, a message allowing participation in the electronic game.

10. The system according to claim 9, wherein the advertisement is a pre-roll advertisement.

11. The system according to claim 9, wherein the electronic game is an electronic gambling game.

12. The system according to claim 11, wherein the advertising revenue is added to a winnable pot of the electronic gambling game.

13. The system according to claim 9, wherein the advertising revenue is converted into digital currency.

14. The system according to claim 9, wherein the advertising revenue is converted into game points.

15. The system according to claim 9, wherein displaying the advertisement by the user device further comprises displaying a banner advertisement.

16. The system according to claim 15, wherein, at a predetermined interval, the displayed banner advertisement is a special banner advertisement which generates a prize if selected by a user.

17. An apparatus for operating an electronic gaming system, the apparatus including a processor and a memory storing instructions which, when executed by the processor, cause the apparatus to:
receive, from a game-operating device, a message requesting an advertisement;
send, to an advertisement-providing device, a message requesting an advertisement;
receive, from the advertisement-providing device, an advertisement;
send, to the game-operating device, the advertisement;
receive, from the game-operating device, a message indicating that the advertisement has been displayed by a user device;
send, to the advertisement-providing device, a message indicating that the advertisement has been displayed;
receive, from the advertisement-providing device, advertising revenue based on the displayed advertisement;
generate currency based on at least a portion of the received advertising revenue; and send, to the game-operating device, the currency.

18. The apparatus according to claim 17, wherein the advertising revenue is added to a winnable pot of an electronic gambling game.

19. The apparatus according to claim 17, wherein the advertising revenue is converted into digital currency.

20. The apparatus according to claim 17, wherein the advertising revenue is converted into game points.

21. The method according to claim 1, further comprising:
determining whether a condition has been met indicating that a user has won the electronic game; and
distributing at least a portion of the currency to a winning user.
